(19) United States
(12) Patent Application Publication
(10) Pub. No.: US 2004/0213595 A1
(43) Pub. Date: Oct. 28, 2004

(54) Limited capacity image-forming machine

(76) Inventor: Bobo Wang, Palos Verdes Estates, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/422,361

(22) Filed: Apr. 24, 2003

(51) Int. Cl. G03G 21/02

(52) U.S. Cl. 399/79

(57) ABSTRACT

The present invention provides a limited capacity image-forming machine that forms a predetermined and limited number of images at which time the limited capacity image-forming machine must then either be reprogrammed or serviced by the manufacturer in order to form additional images. In one embodiment the image-forming machine includes a limited supply of consumables, such as developer or substrate, wherein the consumables cannot be replenished by the user. By preventing a user from replenishing the consumables, the image-forming machine can only form a predetermined and limited number of images. In one embodiment, the image-forming machine is programmed to form a predetermined and limited number of images.

### BACKGROUND OF THE INVENTION

1. Field of the Invention

This invention relates generally to image-forming machines and methods and, more particularly, this invention relates to a limited capacity image-forming machine that that forms a predetermined and limited number of images.

2. Background Art

Image-forming machines are commonly used to form or create images onto a substrate, such as paper. An image-forming machine may typically include developer, such as liquid ink, solid ink, liquid toner or dry toner, which is used to create an image onto the substrate. The developer is usually stored in a removable container within the image-forming machine so that when the image-forming machine has depleted all of the developer, a user may replenish the developer. If the developer is a dry toner, then a fuser would be needed to fuse the dry toner to the substrate. Additionally the image-forming machine, and specifically, parts within the image-forming machine, are typically serviceable if the parts with the image-forming machine break down. Therefore, for example, if a part, such as a print engine, within an image-forming machine breaks down, the user, or a service technician called in by the user, may readily repair the machine.

The image-forming machine also typically includes space for storing the substrate. The substrate is usually stored in an area within the image-forming machine that is accessible to the user, so that when the image-forming machine has depleted all of the substrate, a user may replenish the substrate. Moreover, a feeder is typically used to feed the substrate into the image-forming machine. Image-forming machines are typically not made to be disposable, but rather, are made to last for a substantial period of time. Since image-forming machines are made to last a substantial period of time, the parts within the image-forming machines are relatively costly.

The use of a feeder, a fuser, and/or user-serviceable parts and user-replaceable developer increases the costs and complexity of the image-forming machine. Accordingly, there is a need for an image-forming machine that does not have a feeder, a fuser, and/or user-serviceable parts and user-replenishable consumables, such as developer and substrate, in order to reduce the cost and complexity of the image-forming machine. Additionally, there is a need for an image-forming machine that is not made to last for a substantial period of time and therefore can use less expensive parts in order to reduce the cost of the image-forming machine. Moreover, there is a need for an image-forming machine in which the user may purchase for use a limited or set number of times and then dispose of or replace.

### BRIEF SUMMARY

According to one aspect of the present invention, a limited capacity image-forming machine is provided. The image-forming machine has a substantially sealed housing. The image-forming machine also has a fixed amount of developer within the sealed housing, whereby a user is prevented from replenishing the developer.

According to another aspect of the present invention a method is provided that includes providing a limited capacity image-forming machine to a user. The image-forming machine is designed to form no more than approximately a predetermined number of images. The image-forming machine has a predetermined and limited supply of developer. The developer cannot be normally replenished by the user.

According to another aspect of the present invention a method is provided that includes providing a limited capacity image-forming machine to a user. The image-forming machine has a limited supply of developer. The developer cannot be normally replenished by the user. The method also includes programming the image-forming machine to form a predetermined number of images.

The following drawings and descriptions set forth additional advantages and benefits of the invention. More advantages and benefits will become apparent to those skilled in the art after reviewing the description and may be learned by practice of the invention.

### BRIEF DESCRIPTION OF SEVERAL VIEWS OF THE DRAWINGS

FIG. 1 shows a perspective view of a limited capacity image-forming machine, according to one embodiment of the present invention;

FIG. 2 shows a cross-sectional view of the image-forming machine of FIG. 1, according to one embodiment of the present invention;

FIG. 3 shows a perspective view of a limited capacity image-forming machine, according to one embodiment of the present invention; and

FIG. 4 shows a cross-sectional view of the image-forming machine of FIG. 3, according to one embodiment of the present invention.

FIG. 5 is a flowchart illustration of methods, apparatus (systems) and computer program products, according to one embodiment of the present invention.

For simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION

The present invention discloses a limited capacity image-forming machine. The limited capacity image-forming machine forms a predetermined and limited number of images at which time the limited capacity image-forming machine must then either be reprogrammed or serviced by the manufacturer in order to form additional images. In one embodiment the limited capacity image-forming machine includes a limited supply of consumables, such as developer and/or substrate, wherein the consumables cannot be replenished by the user. For example, in one embodiment, the image-forming machine includes a predetermined and limited supply of developer that cannot be replenished by a user. In another embodiment, the image-forming machine includes a predetermined and limited supply of substrate that cannot be replenished by a user. By substantially preventing a user from replenishing the consumables, the image-forming machine can only form a predetermined and limited number of images. In one embodiment, the image-forming machine is programmed to form a predetermined and limited number of images. By programming the image-forming machine to form a predetermined and limited number of images, the image-forming machine must be reprogrammed to form additional images, unlike conventional printers. In one embodiment, the cost of the image-forming machine is reduced by not including a substrate feeder, a fuser, and/or user-serviceable parts and user-replaceable developer within the image-forming machine. Additionally, in one embodiment, the image-forming machine is not manufactured to last for a substantial volume of production and therefore includes less expensive parts in order to reduce the cost of the image-forming machine. In the preferred approach, a user would intentionally purchase this image-forming machine for a limited or set number of times and then dispose of the machine or replace it.

Shown in FIGS. 1-4 are limited capacity image-forming machines 20 and 120. Each of these limited capacity image-forming machines form a predetermined and limited number of images beyond which the image-forming machine 20, 120 must be serviced or reprogrammed by the manufacturer in order to form an additional number of images. For example, the image-forming machine 20, 120 may be designed to form no more than a limited, predetermined number of images, such as 2000, 5000, or even 10,000 images, by including a limited supply of consumables 29, such as developer 30 and substrate 40 (e.g. paper), wherein the consumables 29 cannot be readily replenished by the user. Additionally, the image-forming machine 20, 120 may be programmed to form a limited number of images as well. Once the image-forming machine has formed that predetermined and limited number of images, the image-forming machine must either be serviced or re-programmed by the manufacturer in order to form an additional amount of images. Preferably, the limited capacity image-forming machine 20, 120 does not include user-serviceable parts and/or user-replenishable consumables 29. As defined herein, image-forming machine 20, 120 includes various types of components that form images, such as those components found in electrophotographic image-forming machines (e.g. copy machines, laser printers) and any other printer that uses charged developer to form an image (e.g. ink jet printers and dot matrix printers). Preferably, the image forming machine 20, 120 is a printer which uses liquid toner to form an image, since liquid toner does not require the use of a fuser. Fusers would increase the cost and weight of the image forming machine.

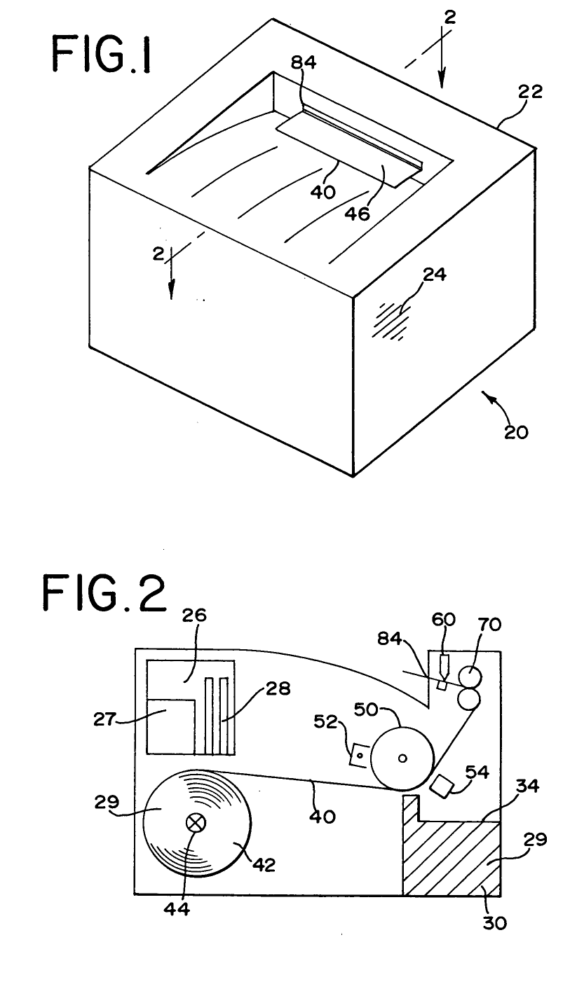

Shown in FIGS. 1 and 2 is a limited capacity image-forming machine 20 which includes a limited amount of consumables 29, such as developer 30 and substrate 40, within the substantially sealed housing 22. Image-forming machine 20 is capable of forming only a predetermined and limited number of images before the image-forming machine 20 runs out of those consumables. Once the image-forming machine 20 runs out of consumables 29, the manufacturer of the image-forming machine 20 must replenish the consumables 29 and replace any worn components within the image-forming machine 20, in order for the image-forming machine 20 to form an additional amount of images. In fact, because the manufacturer of the image-forming machine 20 knows that the image-forming machine 20 is capable of forming only a predetermined and limited number of images, the manufacturer may use less robust components to build the image-forming machine 20. The use of less robust components, allows for the image-forming forming machine 20 to be built at a reduced cost. Similarly, by intending that the user is prevented from replenishing the consumables in some manner, the need to provide additional mechanisms for facilitation of opening and closing of the unit may also be avoided.

In one embodiment, image-forming machine 20 includes a housing 22 that is sealed to prevent the user from accessing the consumables 29 and replenishing them. The housing 22 houses components within the image-forming machine 20 and the consumables. The housing 22 is constructed from a rigid material, such as, but not limited to: metals such as iron, steel, aluminum, titanium, and brass; plastics such as ethylene-vinyl acetate; acrylics such as acrylonitrile-butadiene-styrene and acrylic-styrene-acrylonitrile; polymers such as polycarbonate, polyurethane, polythylene, polybutylene, polyvinyl chloride, polyphenylene oxide, chlorinated polyvinyl chloride, polyamides, and polybutylene terephthalate; carbon fiber; graphite; and any other rigid material known to those skilled in the art. Housing 22 may be formed in one of many ways known to those skilled in the art, such as die-casting, machine forming, and molding. Preferably, housing 22 is formed using molded plastic, since plastic is relatively lightweight and inexpensive. Housing 22 acts as a base for mounting parts such as electronics housing 26, spool 44 and roll of paper 42, developer 30, imaging loop 50, feed rollers 70, and paper cutter 60.

The housing 22, is substantially sealed so as to substantially prevent a user from accessing elements within the housing such as electronics housing 26, spool 44 and roll of paper 42, developer 30, imaging loop 50, feed rollers 70, and paper cutter 60, and any other such items found within the image-forming machine 20. The housing 22 may be sealed using one of many various different types of fasteners, including: mechanical fasteners such as screws, bolts, snap-fit members, and pins; and adhesive fasteners such as epoxy. Alternatively, the housing 22 may be sealed using pressure, heat such as welding the housing shut, and by molding certain pieces of the housing 22 together. While it cannot be made impossible to open the housing 22 and access the consumables 29 and other parts within the housing 22, the housing 22 is sealed in such a way so as to prevent a typical user from opening the housing and accessing parts or consumables 29 within the housing 22. Preferably, the housing 22 is sealed to preclude user access, but to allow the manufacturer to access components, replenish consumables 29 and reprogram the apparatus from within the housing 22. For example, the housing may be sealed using a lock-type fasteners with a key, wherein the manufacturer, and not the user, has the key.

Preferably, the image-forming machine 20 includes a predetermined and limited supply of developer 30 within the sealed housing 22, as illustrated in FIG. 2. As defined herein, developer 30 is any material that can be used to create an image onto a substrate, such as liquid ink, solid ink, solid toner, liquid toner, or any other type of chemical or material which can impart an image onto a substrate. Preferably, the developer 30 includes liquid toner. More preferably, the developer 30 is stored within the housing 22 in such a way so that a user is prevented from replenishing the developer 30. For example, in one embodiment, the image-forming machine 20 includes a sealed reservoir 34 within the sealed housing 22. The developer 30 is stored within the sealed reservoir 34 found within the sealed housing 22. Since the reservoir 34 is sealed, a user is discouraged from entering or opening the sealed reservoir 34 and cannot easily access the developer 30. Furthermore, by placing the sealed reservoir 34 inside the sealed housing 22, the user is further discouraged or prevented from replenishing the developer 30. In one embodiment, the sealed reservoir 34 is molded or fixedly attached to the housing 22 so that a user is discouraged or prevented from removing the sealed reservoir 34, and the developer 30 within the sealed reservoir 34, from the housing 22. In one embodiment, the sealed reservoir 34 is formed integrally with the housing 22 in order to further reduce the costs of manufacturing the image-forming machine 20.

In one embodiment, the image-forming machine 22 includes a predetermined and limited supply of substrate 40 within the sealed housing 22. By including the substrate 40 within the sealed housing 22, the image-forming machine 20 does not need to have a feeder to feed additional substrate into the image-forming machine 20, reducing the costs of manufacturing the image-forming machine 20. Image-forming machine 20 uses developer 30 to create and impart an image onto the substrate 40. Substrate 40 includes any type of material that can be used to impart and form an image onto, such as paper, plastic, and the like. Since the substrate 40 is sealed within the housing 22, a user is prevented from replenishing the substrate 40. Additionally, by placing a predetermined and limited amount of substrate 40 within the housing 22, the image-forming machine 20 is only capable of only forming a predetermined and limited number of images. In a preferred embodiment, the substrate 40 includes a roll of paper 42 within the housing 22. The roll of paper 42 is wrapped around a spool 44, as illustrated in FIG. 2. Preferably, the spool 44 is fixedly attached to the housing 22 so as to further prevent the user from replenishing the substrate 40. Preferably, the image-forming machine 20 include a paper cutter 60 located within the housing 22. The paper cutter 60 cuts the roll of paper 42 into individual sheets of paper 46 which exit the image-forming machine 20 at an exit 84, as illustrated in FIGS. 1 and 2. In this manner, because the substrate is a continuous web, the image-forming apparatus can “feed” the substrate through the use of a single set of driven rollers, such as feed rollers 70.

Preferably, the image-forming machine 20 includes an electronics housing 26, an imaging loop 50, and feed rollers 70, as illustrated in FIG. 2. The electronics housing 26 houses electronic components, such as a power supply 27 and a circuit board 28, that are within the housing 22. The electronics housing 26 is electrically connected to electronic components, all of which are not shown, within the imaging-forming machine 20, such as: sensors; network interfaces; electrical connectors; and electronic motors used to rotate such things as the spool 44, the imagine loop 50, and the feed rollers 70. The imaging loop 50 is located within the housing 22 and is used to form an image onto the substrate 40. The imaging loop 50 has certain areas that are selectively charged to attract the developer 30 to those areas. As the substrate 40 passed near the imaging loop 50, the developer is drawn to the charged areas of the imaging loop and onto the substrate 40. In one embodiment, the developer 30 includes dry toner and the image-forming machine 20 includes a fuser 54, located within the housing 22, to fuse the dry toner to the substrate 40, as illustrated in FIG. 2. The feed roller are also located within the housing 22 and are used to help feed the substrate 40 through the housing 22 and out of the housing 22 at exit 84.

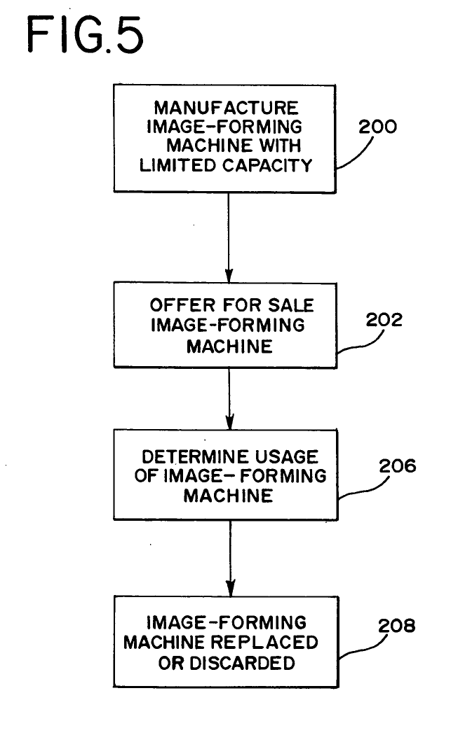

In one embodiment, the image-forming machine 20 includes an exposure unit 52, 152 which is used to expose an area on the imaging loop 50, 150, as illustrated in FIGS. 2 and 4. Exposure unit 52, 152 may be any device that is used to expose or charge an area, such as a charger. For example, if the image-forming machine 20, 120 uses dry toner or liquid toner, then, in order to form an image, certain areas on the imaging loop 50, 150 need to be exposed or charged in such a way as to attract dry toner or liquid toner particles onto the imaging loop 50, 150 and then later transferred to the substrate 40. If the image forming machine 20 uses dry toner, then the image-forming machine 20 also includes a fuser 54 which is located downstream from the exposure unit 52 and which is used to “fuse” or affix the dry toner to the substrate 40, as illustrated in FIG. 2.

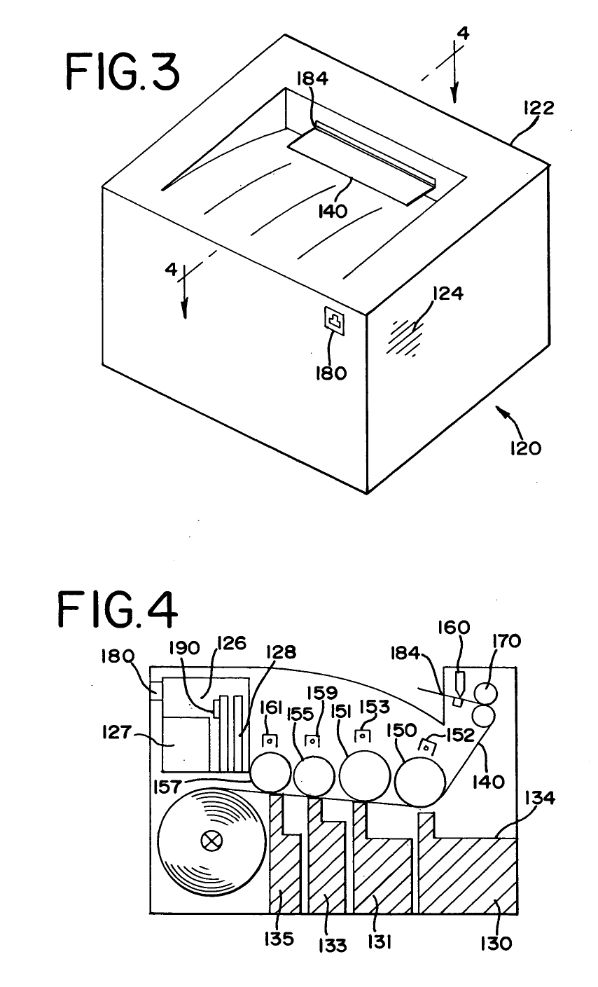

In one embodiment, the image-forming machine 120 is programmed by the manufacturer to form a predetermined number of images, as illustrated in FIGS. 3 and 4. In this embodiment, the number of images formed by image-forming machine 120 is determined based upon a programmed amount that is input into the image-forming machine 120. Preferably, the image-forming machine 120 includes a programmable device 190 that stores the programmed amount. The programmed amount is programmed onto the programmable device 190 by the manufacturer. In one embodiment, the programmed amount is determined by an amount of money received by the manufacturer from the user. Preferably, the image-forming machine 120 includes a limited supply of consumables 29, such as developer 130 and substrate 140, wherein the consumables 29 cannot be replenished by the user. In one embodiment, the image-forming machine 120 includes a network interface 180 which allows the image-forming machine 120 to communicate with another device, such as a computer server, over a network. By using the network interface 180, a manufacturer is able to remotely program the image-forming machine 120 to form a predetermined and limited number of images. Image-forming machine 120 allows an image-forming machine that forms a predetermined and limited number of images to be provided to a user regardless of whether the image-forming machine 120 includes a predetermined and limited capacity of developer 130 or substrate 140.

Preferably, image-forming machine 120 also includes an electronics housing 126 with a power supply 127 and a circuit board 128 connected with the programmable device 190, an imaging loop 150, feed rollers 170, a paper cutter 160, and an exit 180, which correspond to element similar element numbers in image-forming machine 20, as described above.

In one embodiment, image-forming machine 120 forms images comprising multiple colors, and preferably, comprising at least four colors. In this embodiment, preferably, image-forming machine 120 has more than one exposure unit 152 and more than one developer station, as illustrated in FIG. 4. In one embodiment, image-forming machine 120 has four imaging loops 150, 151, 155, 157, four exposure units 152, 153, 159, 161, and four developer stations 130, 131, 133, 135, as illustrated in FIG. 4, to form images in full-color.

Accordingly, by providing a limited capacity image-forming machine 20 with a limited supply of developer or substrate, the limited capacity image-forming machine 20 can have a reduced cost and complexity in comparison to a conventional printer. Additionally, by providing an image-forming 120 with a limited capacity, that is by providing a image-forming machine that can only produce a limited amount of images before it must be serviced at the factory or reprogrammed, a user may purchase only the amount of images that the user may need at the time instead of having the user purchase an image-forming machine that is capable of forming an amount of images that is more than the user may need. A limited capacity image-forming machine 20, 120 may also provide a user with an all-in-one solution for producing images, if the image-forming machine includes a limited supply of developer and/or substrate, so that the user does not have to concern himself with obtaining the developer or substrate, since they are included in the printer.

FIG. 5 is a flowchart illustration of methods, apparatus (systems) and computer program products according to the invention. It will be understood that certain blocks of the flowchart illustration in FIG. 5, and certain combinations of blocks in the flowchart illustration in FIG. 5, can be implemented by computer program instructions. These computer program instructions may be loaded onto a computer or other programmable data processing apparatus to produce a machine, such that the instructions which execute on the computer or other programmable data processing apparatus create means for implementing the functions specified in the flowchart block or blocks. These computer program instructions may also be stored in a storage device that can direct a computer or other programmable data processing apparatus to function in a particular manner, such that the instructions stored in the storage device produce an article of manufacture including instruction means which implement the function specified in the flowchart block or blocks. The computer program instructions may also be loaded onto a computer or other programmable data processing apparatus to cause a series of operational steps to be performed on the computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

As seen in FIG. 5 the manufacturing of an image-forming machine 20 with a limited capacity, in accordance with the present invention, is initiated in block 200. Preferably, the image-forming machine 20 is manufactured using inexpensive components. Upon manufacturing the image-forming machine 20, the image-forming machine 20 is then offered for sale to potential buyers, at block 202. Preferably, the image-forming machine 20 is advertised as a limited capacity image-forming machine, wherein the limited capacity is clearly stated or labeled on the image-forming machine 20 or on or within packaging that surrounds the image-forming machine 20. The image-forming machine 20 may be offered for sale as a one-time purchase, as a per-use basis, or as a subscription service in which a periodic payment is requested. Preferably, in offering the image-forming machine 20 for sale, the manufacturer determines the price of the image-forming machine 20. In one embodiment, if the image-forming machine 20 is offered for sale the purchase price of the image-forming machine 20 is based upon the limited capacity. Therefore, if the limited capacity is increased, so is the purchase price. In one embodiment, if the image-forming machine 20 is offered for sale on a per-use-basis, a minimal set price for the image-forming machine 20 is determined, and the user is charged for the image-forming machine 20 based upon the number of images formed as the images are formed. In one embodiment, if the image-forming machine 20 is offered for sale as a subscription service, a fee is determined on a periodic basis. Preferably, the periodic fee is based upon an actual or estimated use. In this embodiment, the user is billed a fee on a periodic basis based upon the actual amount of images formed or based upon an estimate of the images formed. Additionally, the user may be billed a fee on a periodic basis based upon other factors as well, such as, the amount of images the user wishes to be formed.

Upon offering the image-forming machine 20 for sale at block 202, the amount of images formed by the image-forming machine 20, also known as the usage, is determined, as shown in block 206. Preferably, the usage is determined by the manufacturer. In one embodiment, the usage is determined by querying the image-forming machine 20 for information that indicates the usage based upon a set period. In another embodiment, the usage is determined by the user. Upon determining the usage, the user may be charged a certain amount based upon the usage. The usage may be predetermined before the sale of the image-forming machine 20. If the image-forming machine 20 is offered for sale as a one-time purchase, the usage is determined by the manufacturer before offering the image-forming machine 20 for sale at block 202. In one embodiment, the image-forming machine 20 determines its own usage and communicates this to the manufacturer. For example, the image-forming machine 20 may have a counter that counts the number of images formed and then relays this number to the manufacturer through a networked connection, such as the Internet.

Upon determining the usage at block 206, the image-forming machine 20 is either replaced or discarded by the manufacturer, as shown at block 208. At some time after the image-forming machine 20 is purchased, the image-forming machine 20 is spent and can no longer form any images. At this time, the user must either return the spent image-forming machine 20 to the manufacturer or discard the spent image-forming machine 20, as illustrated in block 208. In one embodiment, if the user chooses to return the spent image-forming machine 20, the user may replace the spent image-forming machine at no cost or at little cost. In one embodiment, the user must replace the spent image-forming machine 20 or pay an additional fee. In one embodiment, the user must return the spent image-forming machine 20 to the manufacturer in order to receive back a deposit amount given when the image-forming machine 20 was purchased. The user may replace the spent image-forming machine 20 by returning the spent image-forming machine 20 to the manufacturer and by the manufacturer giving the user a new or refurbished image-forming machine 20. Upon receiving the spent image-forming machine 20 from the user, the manufacturer then refurbished or discards at least portions of the spent image-forming machine 20. In one embodiment, upon receiving the spent image-forming machine 20, the manufacturer delivers a new or refurbished unit to the user.

While the invention has been described and illustrated, this description is by way of example only. Additional advantages will occur readily to those skilled in the art, who may make numerous changes without departing from the true spirit and scope of the invention. Therefore, the invention is not limited to the specific details, representative machines, and illustrated examples in this description. Accordingly, the scope of this invention is to be limited only as necessitated by the accompanying claims.

1. A method comprising:
providing a limited capacity image-forming machine to a user, wherein the image-forming machine is designed to form a predetermined and limited number of images, wherein the image-forming machine comprises a predetermined and limited supply of developer, and wherein the developer cannot be replenished by the user.

2. The method of claim 1, wherein the image-forming machine comprises a predetermined and limited supply of substrate, and wherein the substrate cannot be replenished by the user.

3. The method of claim 1, wherein the developer comprises liquid toner.

4. The method of claim 1, wherein the image-forming machine comprises a housing, and wherein the developer is sealed within the housing to prevent the user from replenishing the developer.

5. The method of claim 1, wherein the image-forming machine forms a set number of limited number of images based upon an amount of money received from the user.

6. The method of claim 1, further comprising programming the image-forming machine to form a set number of images based upon an amount of money received from the user.

7. The method of claim 1, further comprising refurbishing the image-forming machine at a factory, wherein upon refurbishing the image-forming machine, the image-forming machine may form an additional limited number of images.

8. The method of claim 1, wherein the images comprise multiple colors.

9. A limited capacity image-forming machine comprising:
a sealed housing; and
a fixed amount of developer within the sealed housing, wherein a user is prevented from replenishing the developer.

10. The image-forming machine of claim 9, wherein the developer comprises liquid toner.

11. The image-forming machine of claim 9, wherein the developer is located in a sealed reservoir that is fixedly secured to the housing so that the user is further prevented from replenishing the developer.

12. The image-forming machine of claim 9 further comprising a fixed amount of substrate within the sealed housing, wherein the user is prevented from replenishing the substrate.

13. The image-forming machine of claim 12, wherein the substrate is located in a sealed reservoir that is fixedly secured to the housing so that the user is further prevented from replenishing the substrate.

14. The image-forming machine of claim 12, wherein the substrate comprises a roll of paper.

15. The image-forming machine of claim 13, wherein the roll of paper is fixedly secured to the housing so that the user is prevented from removing the roll of paper from the housing.

16. A method comprising:
providing a limited capacity image-forming machine to a user, wherein the image-forming machine comprises a limited supply of developer, and wherein the developer cannot be replenished by the user; and
programming the image-forming machine to form a predetermined number of images.

17. The method of claim 16, wherein the number of images is determined based upon an amount of money received from the user.

18. The method of claim 16, wherein the image-forming machine comprises a limited supply of substrate, and wherein the substrate cannot be replenished by the user.

19. The method of claim 16 further comprising refurbishing the image-forming machine at a factory, wherein upon refurbishing the image-forming machine, the image-forming machine may form an additional limited number of images.

20. The method of claim 16, wherein the image-forming machine includes a network interface which allows the image-forming machine to be connected to a network of computers.

21. The method of claim 16, wherein the developer comprises liquid toner.

22. The method of claim 16, wherein the image-forming machine forms images with multiple colors.
